(19) United States
(12) Patent Application Publication
(10) Pub. No.: US 2003/0208384 A1
(43) Pub. Date: Nov. 6, 2003

(54) Agent appointment process via a computer network

(75) Inventors: Letitia A. Nelson, Algonquin, IL (US); Gregory A. Bodi, Chicago, IL (US); Sean Carroll, Mundelein, IL (US); Carl D. Jensen, Hoffman Estates, IL (US); Angela D. McAuliffe, McHenry, IL (US); Peter P. Rill, Hawthorn Woods, IL (US); Michael E. Sladek, Skokie, IL (US); Ivor Tham, Palatine, IL (US); Shawn Chen, Libertyville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Federal Kemper Life Assurance Company, Schaumburg, IL

(21) Appl. No.: 10/138,226

(22) Filed: May 1, 2002

(51) Int. Cl. G06F 17/60

(52) U.S. Cl. 705/4

(57) ABSTRACT

An online system using a computer network for accepting applications for the appointment of an agent by an insurance carrier. The system interacts with the agent, a general agent contracting with the agent and licensing staff of the insurance carrier. In one implementation, the system is adapted to perform at least the following steps: receiving an appointment application for the appointment of an agent by an insurance carrier via the computer network, the appointment application including agent data, a state the agent is seeking an appointment, and a product the agent wishes to solicit; transmitting a request for additional information about the agent from an external database via the computer network; and receiving the additional information from the external database via the computer network. By way of example, the additional information may be license information and/or securities registration information for the agent.

### BACKGROUND OF THE INVENTION

1. Field of the Invention

The present invention relates generally to the appointment of agents in the insurance business, and more specifically to the process of obtaining an appointment with an insurance carrier that will allow an agent to be able to sell the insurance carrier's products.

2. Discussion of the Related Art

Professionals in a variety of disciplines, including insurance agents, provide services under license by state, federal or other accrediting bodies. For example, insurance agents (also referred to as producers) are required to be licensed in each state in which they conduct business. Each state requires a license examination before issuing an insurance agent license.

It is common for insurance agents to work with a number of types of companies doing business in a wide variety of disciplines. For example, property-casualty insurance companies, banks, broker-dealers, third party marketers and life insurance companies all rely on a body of insurance agents to solicit and/or administer insurance coverages.

In order to provide insurance products from a given insurance carrier, as a general proposition, an agent must have an appointment from that insurance carrier to sell its products. The appointment is generally a confirmation from a given state to a given insurance carrier that a state-licensed agent is eligible to represent the insurance carrier in the sale of its products. Thus, in order to sell insurance products from a given insurance carrier in a given state, an agent must be licensed in that state and be appointed in that state for the given insurance carrier. Often, a single agent may be licensed in more than one state and will offer products from several insurance carriers. Thus, the agent is required to obtain an appointment for each insurance carrier by that state. Therefore, a single agent may be licensed in more than one state and may have several appointments in each state.

In order to seek an appointment for a given carrier by a state, the given insurance carrier collects and provides information to the state. Initially, an agent who contracts directly with the insurance carrier manually fills out an application request and transmits the application via facsimile or mail along with a copy of the agent's license information for the given state(s) to the insurance carrier. In order to process the appointment, the insurance carrier will perform a background check on the agent, which typically requires an authorization from the agent. Thus, the agent is often required to transmit via facsimile or mail a signature authorization for the insurance carrier to perform the background check.

Next, if the agent utilizes a general agent (GA), the insurance carrier oftentimes requires a commission level. A general agent contracts with many agents in exchange for a percentage of each agent's business. The general agent provides administrative support for the agents. The commission level (also referred to as the contract level) is the percentage of the agent's business from the sales of insurance products by the agent that is payable by the carrier. In these cases, in order for the insurance carrier to process the appointment, the general agent must transmit via facsimile or mail its authorization for the appointment and the contract level or commission as agreed between the agent and the general agent. At that point, the insurance carrier processes the appointment request.

In some instances, the insurance carrier does not contract directly with the agent, but contracts with a general agent. In this instance, the general agent applies for an appointment for the agent as a service to the agent. Thus, the general agent transmits via facsimile or mails an application for the appointment of the agent to the insurance carrier along with a copy of the license information for the agent. If the general agent does not possess the agent's license information, the general agent must obtain the license information in order to complete the appointment request. Additionally, since the insurance carrier does not contract directly with the agent, the insurance carrier requires an authorization from the agent allowing the carrier to perform a background check on the agent. This background check authorization is typically transmitted via facsimile to the insurance carrier directly from the agent or from the general agent. At this point, the insurance carrier processes the appointment request.

Whether the agent applies for an appointment directly or a general agent applies for an appointment on behalf of an agent, the appointment process is time consuming since the agent and/or the general agent must obtain the necessary information and authorizations. Furthermore, the appointment request process generates a significant amount of paperwork for the agent and/or general agent to transmit to the insurance carrier. The amount of paperwork increases as the agent applies to be appointed in more than one state.

What is needed is a simple process for an agent to submit an appointment application to an insurance carrier in one or more states or governing bodies that will reduce the time taken to request the appointment and reduce the amount of physical paperwork necessary to complete the appointment request.

### SUMMARY OF THE INVENTION

The present invention advantageously addresses the needs above as well as other needs by providing an online appointment system utilizing a computer network that is easy to use, saves time and eliminates the need for physical paperwork to be transmitted to an appointing insurance carrier.

In one embodiment, the invention can be characterized as an automated method using a computer network, and a system adapted to perform the method, the method comprising the steps of: receiving an appointment application for the appointment of an agent by an insurance carrier via the computer network, the appointment application including agent data, a state the agent is seeking an appointment, and a product the agent wishes to solicit; transmitting a request for additional information about the agent from an external database via the computer network; and receiving the additional information from the external database via the computer network.

In another embodiment, the invention can be characterized as an automated method using a computer network, and a system adapted to perform the method, the method comprising the steps of: receiving an appointment application for the appointment of an agent by an insurance carrier via a computer network, the appointment application including agent data, a state the agent is seeking an appointment for, and a product the agent wishes to solicit; transmitting, in response to the receiving the appointment application, a request for a background check authorization for display to the agent via the computer network; and receiving an electronically signed background check authorization from the agent via the computer network.

In a further embodiment, the invention may be characterized as an automated method using a computer network, and a system adapted to perform the method, the method comprising the steps of: receiving an appointment application for the appointment of an agent by an insurance carrier via a computer network, the appointment application including agent data, a state the agent is seeking an appointment for, and a product the agent wishes to solicit; transmitting, in response to the receiving the appointment application, a request for display to a general agent contracting with the agent via the computer network, the request for a commission level of the general agent, the commission level being provided in the relationship between the agent and the general agent; and receiving the commission level from the general agent via the computer network.

In another embodiment, the invention may be characterized as a method for application processing via a computer network comprising the steps of: receiving an application from a first party via a computer network, the application containing information from the first party and requiring additional information from a second party to complete the application; determining that the additional information from the second party is needed; automatically transmitting a request for the additional information to the second party via the computer network; and receiving the additional information from the second party via the computer network.

In yet another embodiment, the invention may be characterized as an automated appointment application system using a computer network comprising: a first network interface server for transmitting and receiving web pages via the computer network, the web pages containing an appointment application for the appointment of an agent by an insurance carrier; an application server for processing the information contained in the web pages and for determining if additional information is needed to complete the appointment application; a second network interface server for transmitting electronic notifications via the computer network to the agent and a general agent contracting with the agent, at least one electronic notification indicating that the additional information is required to process the appointment application, the at least one electronic notification including a link to a web page that provides an entry field for the additional information; wherein the application server requests through the web server licensing information about the agent from an external database via the computer network; and a database server for storing the appointment information, the additional information and the licensing information.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a diagram of an appointment application system using a computer network according to one embodiment of the invention;

FIG. 2 is a block diagram of one embodiment of the logical architecture of the appointment application system of FIG. 1;

FIG. 3 is a flowchart illustrating the steps performed in one embodiment of the appointment application system of FIG. 1;

FIG. 4 is a flowchart illustrating the steps performed using one embodiment of the appointment application system in which the appointment application is initiated by a general agent;

FIG. 5 is a flowchart illustrating the steps performed using one embodiment of the appointment application system in which the appointment application is initiated by an agent; and

FIG. 6 is a diagram illustrating the interactions between an agent, a general agent and a licensing staff with an appointment application system according to another embodiment of the invention in which the general agent initiates the appointment application;

FIG. 7 is a flowchart illustrating the steps performed in another embodiment of the invention using a computer network in which information is required from multiple parties in order to complete an application process.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

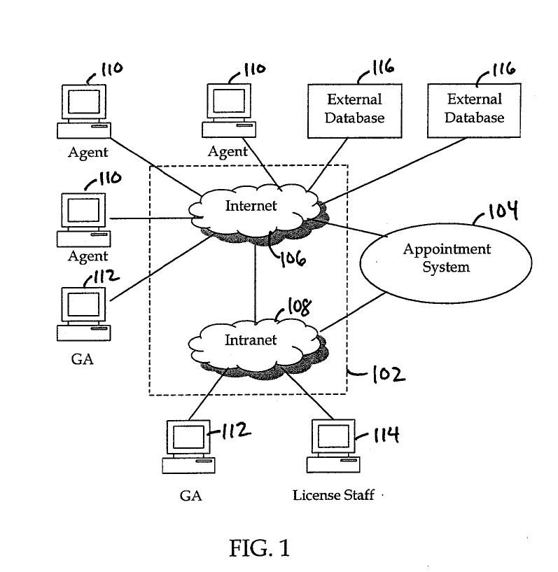

Referring first to FIG. 1, a diagram is shown of an appointment application system using a computer network according to one embodiment of the invention. Illustrated are a computer network 102 and an appointment application system 104 coupled to the computer network 102. The computer network 102 includes an Internet 106 and an intranet 108. Also illustrated are several computers illustrated as agent computers 110 coupled to the Internet 106, general agent computers 112 coupled to the intranet 108 and the Internet 106, and licensing staff computer 114 coupled to the intranet 108. Also illustrated are external databases 116 coupled to the Internet 106.

The computer network 102 is typically an ephemeral interconnection system designed to link computers together and may be made up of servers, routers, bridges, computers, etc. and the various wireless and/or wireline connections therebetween. The computer network 102 is illustrated as including Internet 106 and intranet 108, but it should be recognized that an intranet 108 is not needed. Furthermore, in some embodiments, the computer network 102 may be on a smaller scale than the Internet 106 and may only include an intranet 108 or other local area network (LAN), for example. Thus, a computer network in accordance with several embodiments of the invention can be any network of two or more computers.

It is also noted that the term computer as used throughout is meant to refer to an input and display device coupled to the computer network 102 that constitutes a computer in a basic sense that the device includes a processor and hardware and software to make it addressable to a network of computers. For example, devices such as super computers, servers, personal computers, notebook computers, personal digital assistants or palm devices, network recorders, stationary and mobile telephones, appliances or other electronic devices that include such functionality. Additionally, the computer may be an input and display device that is coupled to another computer that is coupled to the computer network 102. The computers may be general or special purpose computers.

According to one embodiment of the invention, an appointment application system 104 is implemented that provides for the submission of appointment applications or requests for agent appointment to an insurance carrier as known in the insurance community via the computer network 102. For example, the appointment application system 104 is implemented as a website that hosts an appointment application system that transmits pages for display to the various users on their computers via the computer network 102. For example, such a website transmits web pages that are viewed at the user computers through a browser running on the user computer. These web pages are designed so that the users may input data to be transmitted back the system 104.

In the insurance business, in order for a particular agent to be able to sell (i.e., solicit the sale of) products of a given insurance carrier in a given state, the agent must be licensed in the given state and must be appointed by the state for the insurance carrier. This appointment is the state's confirmation that the agent is eligible to represent the insurance carrier in the sale of its products in that state. The appointment is generally obtained through an appointment application, which is initially submitted to the insurance carrier, then provided to the state for final processing.

According to many embodiments of the invention, regardless of whether the insurance carrier contracts with the agent or contracts with the general agent, either an agent or a general agent contracting with the agent may initiate and submit an appointment application via the computer network 102. For example, the agent (e.g., at agent computer 110) or the general agent (e.g., at general agent computer 112) may submit an electronic appointment application on-line using the Internet 106 and/or intranet 108. Thus, the appointment application system 104 includes a server having a processor that runs software to implement the transfer and receipt of the appointment application, for example, through the use of generated web pages and e-mails or other electronic notifications via the computer network 102. Advantageously, since the appointment application is submitted via the computer network 102, the agent or the general agent does not have to manually fill out or physically create (type or hand print) an appointment application. Furthermore, the agent or general agent does not have to fax or mail the application to the insurance carrier. Additionally, as will be described in further detail below, several embodiments of the invention provide additional advantages in that the agent and the general agent are provided means to view, edit and confirm the appointment application via the computer network 102.

Additionally, in some scenarios, information is required from both the agent and the general agent in order to complete the appointment application. For example, in one scenario where the general agent initiates the appointment application on the behalf of the agent, the general agent provides information about the agent, the product(s) the agent desires to solicit the sale of and the state(s) the agent wishes to sell these products in. However, further information is often required from the agent in order to complete the appointment application, such as, a background check authorization from the agent to allow the insurance carrier to perform a background check, which may include the agent's credit report. Furthermore, the general agent may not know all of the information about the agent that is necessary to complete the application, e.g., the full employment history of the agent. In several embodiments, the appointment application system 104 automatically determines that additional information from the agent is required and automatically transmits a request for this additional information to the agent via the computer network 102. For example, in one embodiment, the system 104 automatically transmits an e-mail to the agent requesting the additional information. Furthermore, in some embodiments, this e-mail includes a link to a web page generated by the appointment application system 104 that will provide means for the agent to provide the needed information and transmit it back to the appointment application system 104 via the computer network 102. Thus, in contrast to known methods, the agent is not required to mail or fax a separate background check authorization or mail or fax separate papers containing other additional information.

On the other hand, when the appointment application or request is initiated by the agent, in some embodiments, the appointment application system 104 determines that additional information is required from the general agent, e.g., the commission level or contract level, and automatically transmits a request to the general agent associated with the agent to obtain the additional information needed in order to complete the appointment application. Thus, accordingly, in some embodiments, the appointment application system 104 determines that additional information is required from the non-initiating party and automatically generates and transmits a request for the additional information to the non-initiating party via the computer network 102.

Furthermore, in several embodiments, the agent is not required to manually fax or mail a copy of the agent's license information. Rather, the appointment application system 104 automatically requests license information about the agent from an external database 116, such as the NIPR (National Insurance Producer Registry), via the computer network 102. In other words, the appointment application system “pings” the external database 116 for the licensing information. In one embodiment, the appointment application system 104 automatically requests a web page from the external database 116, e.g., the NIPR website, for a web page that will enable the appointment application system 104 to request licensing information about the agent.

In the event the agent desires to sell variable products, securities registration information, such as provided by the NASD (National Association of Securities Dealers), about the agent is required. Thus, the appointment application system 104 automatically requests a web page from another external database 116, e.g., the NASD website, for a web page that will enable the appointment application system 104 to request securities registration information for the agent. It is noted that as used herein, the external databases 116 may be any external registry, provider, industry depository, or governmental agency accessible via the computer network 102.

In additional embodiments, the appointment application system 104 transmits requests and notifications to licensing staff of the insurance carrier, e.g., at licensing staff computer 114, via the computer network 102. For example, in one embodiment, once an appointment application has been completed and is ready for internal processing by the licensing staff of the insurance carrier, the system 104 transmits an e-mail or other electronic notification to the licensing staff indicating that the application is ready for processing. In states referred to as sensitive states or pre-appointment states, appointment requests are approved by the state before solicitation of products, whereas in other states, an appointment may be processed at the time of submission of the first piece of business. Thus, in some embodiments, the appointment application system 104 determines whether one or more of the states being applied for are sensitive states, i.e., special processing time lines exist for the particular state. According to one embodiment, if a state being applied for is a sensitive state, then the system 104 transmits an e-mail via the computer network 102 to the licensing staff of the insurance carrier signaling the staff to immediately process the appointment application. If there are no sensitive states being applied for, the appointment application system 104 stores the application for later processing.

Furthermore, depending on the embodiment, the appointment application system 104 may be implemented with insurance carriers that contract directly with agents, insurance carriers that contract with general agents on behalf of agents, or insurance carriers that contract with both agents and general agents. Furthermore, appointment applications may be initiated by an agent and/or a general agent regardless of which party contracts with the insurance carrier.

The appointment application system 104 includes both hardware and software to implement an online application process, including the appropriate servers to receive and transmit information via the computer network, as well as the appropriate application software, adapters and handlers to manage and process the data transmitted and received.

It should be understood that although many of the embodiments disclosed herein are described in the context of appointment in a particular state, the principles of the present invention can be applied to the insurance requirements of any state generically or governmental body. Thus, the term state as used herein is meant to refer generically to a private or governmental body or entity. Furthermore, the term appointment in the insurance industry as used herein may be referred by different names depending on the regulations and customs of the insurance industry in a particular state.

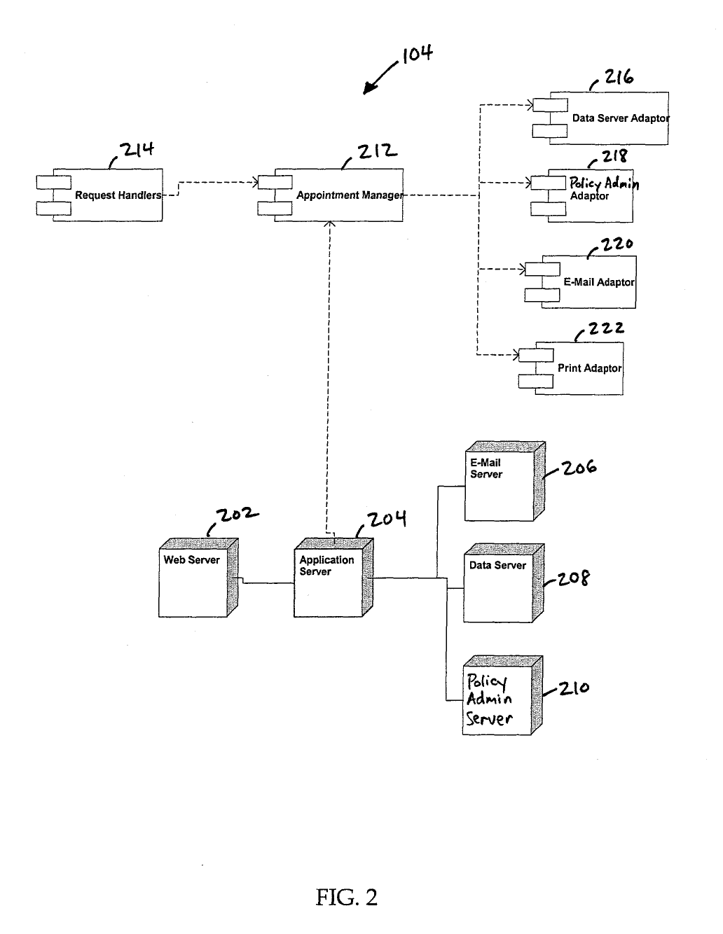

Referring next to FIG. 2, a block diagram is shown of one embodiment of the logical architecture of the appointment application system 104 of FIG. 1. Illustrated are the following network nodes: a web server 202, an application server 204, an e-mail server 206, a database server 208 (for example, a structured query language (SQL) server) and a policy administration/licensing system server 210. It is noted that the web server 204 and the e-mail server 206 may be generically referred to as “network interface servers” such that they are designed to transmit and receive information to and from the computer network 102. Also illustrated are application software components that are stored in a memory (e.g., RAM and/or ROM) and run on a processor of the application server 204 including an appointment manager 212, request handlers 214, a database server adapter 216 (e.g., an SQL server adapter), a policy administration/licensing system adapter 218, an e-mail adapter 220, and a print adapter 222. It is also noted that the request handlers 214 and the e-mail adapter 220 may be generically referred to as network adapters. It is noted that each of the servers (i.e., web server 202, application server 204, e-mail server 206, database server 208 and policy administration/licensing system server 210) includes memory for storing the appropriate software and a processor for running this software.

The appointment application system 104 is split into three logical tiers. First, the web server 202 manages direct interaction with the users (e.g., located at agent computers 110, general agent computers 112 and licensing staff computers 114), for example, through the HyperText Transmission Protocol Secure (HTTPS) protocol or any other known protocol depending on the user devices with the appropriate request handlers 214. Second, the application server 204 is coupled to the web server 202 and stores and runs application software components (e.g., the appointment manager 212). Third, the three other nodes: the e-mail server, database server, and policy administration/licensing system and the various adapters 216, 218, 220 and 222, all provide access to back-end systems.

In one embodiment, the user interface is implemented as a web site with a combination of Java Server Pages (.JSP pages) and request handlers 214. However, it is understood that this user interface could be implemented using any web page creation format known in the art, and preferably a format that allows for dynamically generated content.

The appointment manager 212 manages the user interface and manages access to the back-end systems. For example, the appointment manager 212 saves and provides access to appointment information, employment history information, commission rate information (e.g., the commission level) and requirement information (e.g., licensing information).

The e-mail adapter 220 is responsible for transmitting requests for additional information and/or corrected requests for corrected information to the agent and/or the general agent depending on the information requested and the initiating party. For example, in one embodiment in which the general agent initiates the appointment application, the e-mail adapter 220 is responsible for transmitting an e-mail to notify the agent that an application is ready for signature (e.g., a background check authorization). Furthermore, in some embodiments, the e-mail adapter 220 is responsible for generating and transmitting an e-mail to the licensing staff of the insurance carrier when an application is received for a sensitive state.

The database adapter 216 is responsible for saving and retrieving appointment applications, employment history information, and application requirements. It is also used to verify and retrieve information about the general agent, and about existing agent, appointment, and hierarchy information. It is noted that a data warehouse (database) is used to feed the database server with agent, general agent, and hierarchy information.

The policy administration/licensing system adapter 218 is responsible for saving agent and licensing data to the policy administration/licensing system of the insurance carrier while the print adaptor 222 is responsible for preparing output that is suitable for printing.

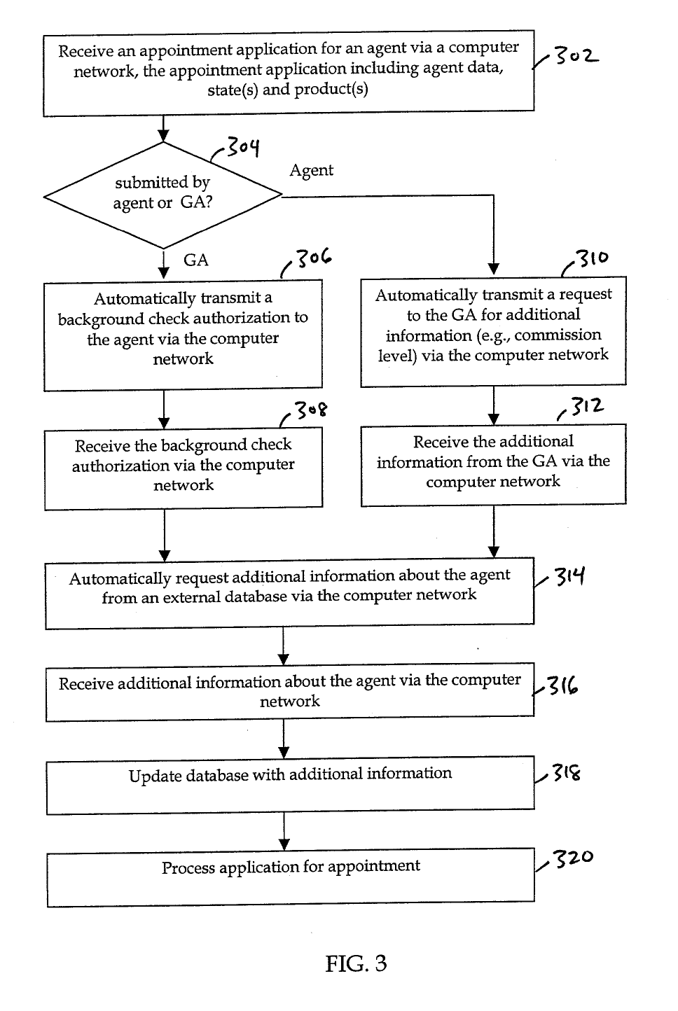

Referring next to FIG. 3, a flowchart is shown that illustrates the steps performed in one embodiment of the appointment application system of FIG. 1. Initially, an appointment application is received for an agent (or producer) via the computer network 102 (Step 302). In one embodiment, the appointment application includes agent data, such as name, address, social security number, telephone number, fax number, e-mail address (i.e., network address), drivers license, employment history and the principal business activity of the agent. The application may also include one or more of the following: the type of entity the appointment is being sought, such as individual, corporation, partnership or sole proprietorship; type of appointment sought, such as life, variable annuity and variable life; state(s) to be appointed to; a product(s) or product line the agent wishes to the solicit the sale of; states already appointed in; desired underwriting companies; and whether the agent is NASD registered. The application may also include information about the general agent including the telephone and fax numbers and e-mail address (i.e., network address). If the application is initiated by a general agent, the application may also include the commission level or contract level of the general agent. Therefore, the appointment application may contain information about both the agent and the general agent including a computer network address (e.g., e-mail address) for both. The information received is stored in a database, e.g., database server 208 using the database server adapter 216.

It is noted that the appointment application may include more or less information about the agent and general agent depending on whether the insurance carrier contracts with the agent or the general agent. For example, the insurance carrier may already possess some of the requested information if it has a contractual relationship with one of the parties. It is also noted that the appointment application may include more or less information or equivalent information depending on the laws regulating the insurance business in a given state or other governing body. It is further noted that the appointment application may contain more or less information depending on whether the application was received from the agent or the general agent, since the initiating party may not have knowledge of all information for the application.

The appointment application is generally received as a result of the process of a user, e.g., an agent or a general agent, logging online to a website that hosts the appointment application system 104 via the computer network 102 and requesting an appointment application page generated by the appointment application system 104. The web server 202 of the system 104 transmits the appointment application page for display (e.g., on the agent computer 110 or the general agent computer 112) to the user via the computer network 102. Thus, according to one embodiment of the invention, it is noted that when a page is transmitted for display to a user via the computer network 102, the page is transmitted to the user's computer via the computer network 102 and is displayed on the user's computer, e.g., using a browser. The user receives the page, views it on the computer using a browser and then fills in the information fields provided in the appointment application page and then transmits the completed page back to the web server 202 via the computer network 102. It is also noted that when the page is received from a user via the computer network, the page is received from the user's computer (e.g., computer 110) via the computer network 102. In one embodiment, these web pages are .JSP pages generated by the appointment manager 212 and transmitted by the web server 204. It is noted that it is well within the ability of one of ordinary skill in the art to generate, transmit and receive such web pages. This is in contrast to known appointment processes in which the user, either the agent or the general agent, must have a copy of the application form to be manually filled out and submitted to the insurance carrier, e.g., by facsimile or mail. It is also noted that the appointment application may be transmitted to the user as multiple web pages that are successively transmitted upon completion of each page, e.g., a separate web page may be generated and transmitted different types of information contained in the appointment application.

The appointment application system 104 also has the ability to determine whether or not the appointment application page(s) is properly filled out or is missing information that is obtainable from the initiating party. Such functionality will prompt the user to continue to fill in information until it is completely filled out. For example, a web page may be transmitted back to the initiating party indicating that another field must be filled out in order to continue. Furthermore, the initiating party is also provided the opportunity to review and edit the information contained in appointment application to ensure that the information entered is accurate.

Assuming that the appointment application is properly filled out, the system 102, e.g., the appointment manager 212, determines if the application is submitted by the agent or by the general agent (Step 304). An application submitted directly from the agent usually results when the agent contracts directly with the insurance carrier (i.e., there is no contract between the carrier and the general agent), whereas, an application initiated by the general agent typically results when the general agent contracts with the insurance carrier on behalf of the agent (i.e., there is no contract between the insurance carrier and the agent). However, it is noted that according to several embodiments, an application may be submitted by an agent that has no contract with the carrier, as long as the agent's general agent contracts with the carrier. Similarly, an application may be submitted by a general agent that has no contract with the carrier on behalf of an agent, as long as the agent contracts with the carrier.

It is noted that in some embodiments, the insurance carrier implementing the appointment application system 104 may only accept applications initiated by only one of the agent or general agent. In these embodiments, Step 304 is not performed and the appropriate following steps are automatically performed. For example, a system that accepts appointment applications only from a general agent will perform Step 302, and then next perform Steps 306 and 308. On the other hand, a system that accepts appointment applications only from an agent will perform Step 302, and then next perform Steps 310 and 312.

If the application is initiated or submitted by the general agent (Step 304), the system 104 automatically transmits a background check authorization for display to the agent via the computer network 102 (Step 306). This is often required by the insurance carrier in order process the appointment request. Since the appointment application received includes a network address for the agent on the computer network 102, e.g., the e-mail address of the agent, the appointment manager 212 extracts this address and generates the authorization, which is transmitted to the agent. In one embodiment, the system 104 transmits an e-mail or other electronic notification to the agent that includes a link (e.g., a hyperlink) to a background authorization page of the appointment application website. As is well understood in the art, the e-mail is transmitted by the e-mail server 206 using the e-mail adapter 220. Thus, the agent effectively requests the background check authorization page from the system 104 in response to the automatically generated e-mail, and then the system transmits this background check authorization page for display to the agent via the computer network 102.

The agent then provides the authorization by electronically signing the background check authorization (e.g., clicking in a box) and transmitting the page back to the system 104. Thus, the background check authorization is received at the system 102 via the computer network 102 (Step 308).

It is noted that in embodiments where the insurance carrier contracts with the agent, the insurance carrier may already have such a background check authorization on file for the agent. Thus, in this case, Steps 306 and 308 are not performed. However, Steps 306 and 308 are performed if the carrier contracting with the agent does not have a background check authorization on file or seeks an updated background check authorization.

It is also noted that in some embodiments, prior to the automatic transmission of the background check authorization (Step 306), a verification and/or a request for further information is automatically transmitted to the agent via the computer network 102, e.g., a validation page is transmitted for display to the agent via the network. For example, in some cases, the general agent does not have all of the information necessary to complete the application, e.g., the general agent may not know all of the details of the agent's employment history, or the general agent has entered incorrect information. In cases where the insurance carrier contracts with the agent, the appointment application may be able to retrieve much of the missing information from the insurance carrier's database or records and insert it into the appointment application. Thus, the system 104 automatically determines that further information is needed or that confirmation is needed and automatically generates an e-mail to the agent containing a link to a web page that will allow the agent to enter the additional information and/or to edit or confirm the information entered by the general agent. At this point, the agent clicks on the link and a validation page is transmitted for display to the agent via the network. Once the agent has confirmed the accuracy of the information or has otherwise edited the information for accuracy, then the system 104 automatically generates and transmits the background check authorization to the agent via the computer network (Step 306). Thus, in this case, a background check authorization page is transmitted directly to the agent as a web page in response to the confirmation of the entered information.

In the event that the application is initiated by the agent (Step 304), the application may require additional information from the general agent, e.g., the commission rate information or commission level. This additional information is often required in cases where the insurance carrier contracts with the agent only, since the carrier does not have a contractual relationship with the general agent. Furthermore, additional information may still be required in the event the insurance carrier contracts with the general agent only, since the information has not been previously provided to the insurance carrier or is not readily accessible to the insurance carrier. Often, the insurance carrier is not aware of the commission level between general agent and the agent. Thus, the appointment application system determines that additional information is required from the general agent. In this scenario, the appointment application system 104 automatically transmits for display via the computer network 102 a request to the general agent for the additional information, e.g., the contract level or the commission rate information (Step 310). In some embodiments, the system 104 extracts the network address of the general agent (e.g., e-mail address) provided by the agent in the submitted application or known to the insurance carrier to generate the request to the general agent. In some embodiments, the request transmitted to the general agent is in the form of an e-mail including a link to a web page generated by the system 104 that includes the necessary fields to be completed by the general agent. Once the general agent has entered the information into the field(s) of the web page, the web page is transmitted back to the system 104. Thus, the system 104 receives the additional information (e.g., commission level information) from the general agent (Step 312) via the computer network 102.

Either path from the decision of Step 304 represents a departure from appointment application or request processes as known in the art. For example, the system 104 determines that additional information is required by the non-initiating party and automatically generates a request and transmits that request to the non-initiating party via the computer network 102. It is noted that although these automatic requests for additional information are in the form of e-mails transmitted to the non-initiating party, in one embodiment, it is understood that these automatic requests may be any type of electronic notification sent in a network transmittable format, e.g., paging, text messaging, video messaging, etc. Conventionally, this information would be provided in response to a fax manually transmitted or a telephone call manually placed from the licensing staff members of the insurance carrier to the party that information was required, and typically is provided in a return fax or mailing. Furthermore, in other conventional approaches, it would be up to the initiating party to contact the non-initiating party and ask that they provide information directly to the insurance carrier or that the information be provided to the initiating party to be forwarded to the insurance carrier. For example, the general agent would need to ask the agent sign a background check authorization and fax it to the insurance carrier or the insurance carrier would have to ask the agent to sign the authorization and fax it back to the carrier. Such practices can lead to immerse amounts of paperwork and communications and coordination between the initiating and non-initiating parties. As described above, such practices may be time consuming, particularly when the agent seeks appointment to a number of states or different governmental entities.

In contrast, the automatic requests that are generated and transmitted by the system 104 eliminate the requirement that the parties fill out and fax paperwork to the insurance carrier and eliminate the need for either party to coordinate with the other party in the application process. The system 104 advantageously operates automatically, which reduces the time spent by the agent, the general agent and the licensing staff in ensuring that the appointment application is completed. Appointment applications can be completed in less time and with less effort by all parties, including the licensing staff of the insurance carrier.

In one embodiment, once the necessary information is obtained from the agent and the general agent, the system 104 automatically requests additional information about the agent from one or more external databases 116 via the computer network 102 (Step 314). This is referred to as “pinging” the external database(s) 116. This additional information includes license information about the agent, e.g., the agent's license for the state the agent is seeking an appointment. Such licensing information is stored in an external database, e.g., in a website maintained by the NIPR. In embodiments in which the agent seeks to sell variable products, the agent must also be securities registered with a broker-dealer. Thus, the additional information may include securities registration information which is also stored in an external database, e.g., in the website maintained by the NASD.

In one embodiment, the appointment manager 212 causes the web server 202 to log on to the external database web site and request the additional information about the agent. Such may be accomplished by requesting a known web page or URL (uniform resource allocator) from the database website. For example, the system 104 executes a “bot” to login to the external database, e.g., the NIPR web site, and navigate through it until it gets the page where the Licensing information for the writing agent is available. A bot, as known in the art, is a software tool for digging through data or for automatically executing instructions necessary to perform a search and retrieve data. One skilled in the art could easily create such a bot to log on to an external website via the computer network and retrieve data.

For example, according to one embodiment requesting license information, the bot would transmit a request for a license information request web page to the external database via the computer network. This license information request web page would subsequently be received at the system via the network 102. Next the bot would retrieve from memory and insert identifying data about the agent into the license information request web page and transmit it to the external database via the computer network. And as a result, a web page would be received from the external database via the computer network that would contain the requested additional information. The bot could then extract this information and store the data into the appointment application.

In another example, in embodiments requesting securities registration information, the appointment application system automatically requests securities registration information about the agent from another external database, i.e., the system also pings the other external database for securities registration information. Similarly, a bot is executed that transmits a request for a securities registration request web page to the external database via the computer network. This securities registration request web page would subsequently be received at the system via the network 102. Next the bot would retrieve from memory and insert identifying data about the agent into the securities registration request web page and transmit it to the external database via the computer network. And as a result, a web page would be received from the external database via the computer network that would contain the requested additional information. The bot could then extract and store the data into the appointment application. One example of such an external database 116 is the NASD website; however, it is understood that any external database accessible via the computer network 102 may be accessed.

It is also noted that additional information requested in Step 314 may include the agent's credit report. For example, the appointment application system automatically transmits a request to a third party vendor authorizing the vendor to obtain a credit report to be transmitted back the system. In some cases, the appointment application system may directly transmit a request to a credit reporting agency for the agent's credit report, rather than utilize a third party to obtain the report. In any case, a bot may be executed to automatically transmit the request to the appropriate party.

In response to this automatic pinging, the additional information (for example, licensing information and/or securities registration information) is received at the system 104 via the computer network 102 (Step 316).

It is noted that depending on the embodiment, this pinging may be fully automatic in that as soon as the received application is complete (e.g., after Step 308 or Step 312), the system 104 triggers the pinging. However, in some embodiments, the automatic pinging is triggered by the licensing staff of the carrier. For example, in some embodiments, once the licensing staff is ready to process the appointment application, the licensing staff indicates so to the system and at that point, the system 104 automatically pings the external database 116, e.g., by executing a bot as described above. In other embodiments, the pinging may occur at any time. For example, it is not necessary that a background check authorization or commission level be obtained prior to pinging for license and securities registration information. Thus, Steps 314 and 316 may occur at any time after Step 302. However, an automatic request for a credit report occurs after receipt of a background check authorization, unless one is already on file.

This automatic pinging represents a departure from the known art in that conventionally, the agent is required to fax or mail a copy of the agent's license information and/or securities registration information directly to the insurance carrier. This may be time-consuming depending on the availability and amount of additional information in the agent's possession. Furthermore, conventional approaches cause the agent to spend time to accomplish this task. In contrast, according to several embodiments of the invention, the system 104 automatically requests and obtains the additional information eliminating the need for the agent or the general agent to send the information to the carrier.

Once the additional information is received (Step 316), the system 102 updates the database with the additional information (Step 318). For example, the appointment manager 212 saves the information to the database using the database server adapter 216.

At this point, the appointment application is ready to be processed by the licensing staff of the insurance carrier (Step 320); however, it is noted that in some embodiments, the licensing staff may have already begun processing, e.g., after the completion of Step 308 or Step 312 and before Step 314.

The order of the steps of FIG. 3 represent only one embodiment and it is noted that the order of these steps may be altered depending on the specific implementation and be in accordance with the invention.

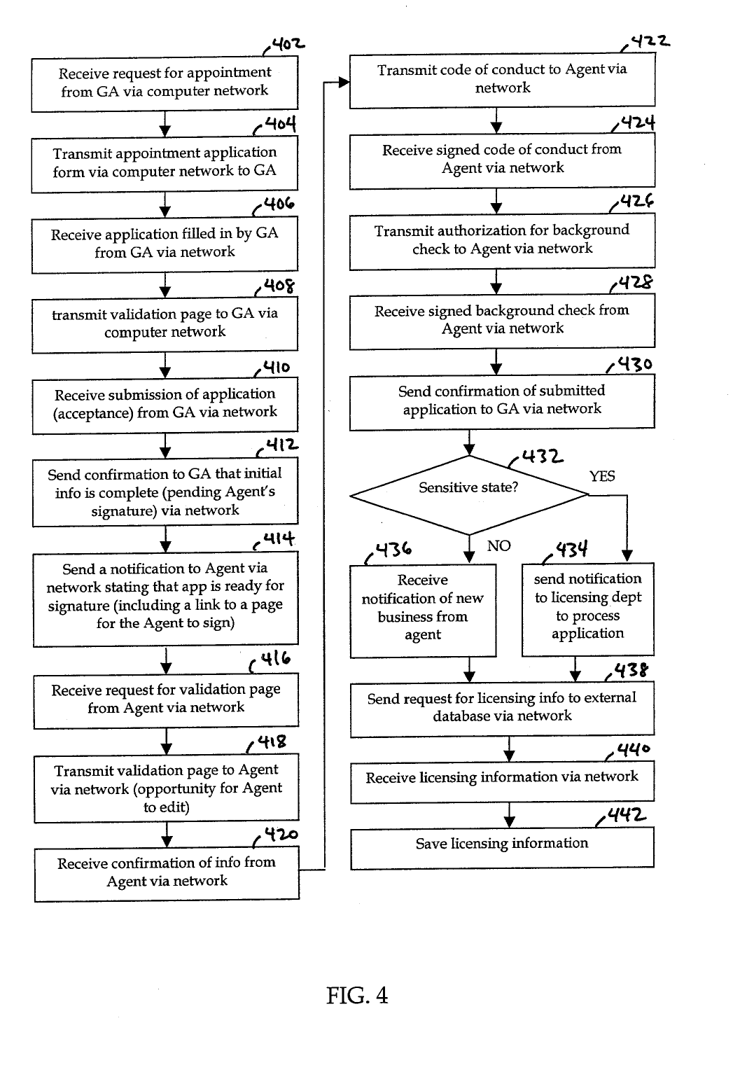

Referring next to FIG. 4, a flowchart is shown illustrating the steps performed using one embodiment of the appointment application system in which the appointment application is initiated by a general agent. Thus, the flowchart of FIG. 4 illustrates in more detail one embodiment of the steps of FIG. 3 as performed by the appointment application system relative to the parties involved including the agent and the general agent.

Initially, a request for an appointment form is received from the general agent (GA) via the computer network (Step 402). For example, the general agent has logged on the appointment application website and has requested the appropriate starting page. Next, the appointment application is transmitted for display to the general agent via the computer network (Step 404), e.g., as one or more web pages (e.g., .JSP pages). It is noted that by transmitting an application for display to a user via the computer network, the application is transmitted to a user's computer via the computer network to be displayed. Likewise, when a page is received from the user via the computer network, the page is received from the user's computer via the computer network. At this point the general agent enters the information known to the general agent about the agent, the state(s) and product(s) applied for (i.e., wishes to solicit the sale of), a computer network address for the agent (e.g., e-mail address), and the commission level or contract level between the agent and the general agent, and then submits the page(s). In embodiments where the insurance carrier does not contract with the general agent, additional information may be required from the general agent. Again, it is noted that the application may be transmitted as multiple pages that are successively transmitted upon the submission of each page. Thus, the application as filled in by the general agent (or filled in to the best of the general agent's ability) is received at the system 104 via the computer network (Step 406). The system stores the application and data in a database, e.g., in the database server 208 using the database server adapter 216. The system then transmits a validation page for display to the general agent via the computer network (Step 408). This validation page allows the general agent to verify the accuracy of the information entered and edit, if necessary. Once the general agent has confirmed the information entered, the general agent submits the application by accepting the validation page. Thus, the system receives an acceptance of the appointment application from the general agent via the computer network (Step 410). At this point, the application is saved in the system database. Next, a confirmation that the initial application is complete pending the agent's signature is transmitted for display to the general agent via the computer network (Step 412). This confirmation indicates that the application is complete from the general agent's standpoint and requires the agent's signature.

Next, a notification indicating that the application is ready for review and signature is automatically transmitted to the agent via the computer network (Step 414). In one embodiment, the notification is an email. According to one embodiment, the e-mail includes a link to a validation page generated by the appointment application system 104 that will display the entered information and prompt for any additional information still required. It is noted that in embodiments where the insurance carrier contracts directly with the agent, the appointment application system supplies some of the additional information for the agent by accessing the insurance carrier's records and populating the appointment application with known information. Thus, a request is received via the computer network from the agent for such a validation page (Step 416), which is then transmitted for display via the computer network to the agent (Step 418). In some embodiments, this validation page contains multiple pages. Again, this validation page provides the agent with the opportunity to add to and review and edit the information. Once the agent has confirmed the information in the application, the agent so indicates, and thus, the system receives via the network a confirmation of the information in the application from the agent (Step 420).

Next, the system transmits a code of conduct for display to the agent via the computer network (Step 422), e.g., within a web page. In one embodiment, the code of conduct is a statement to be acknowledged by the agent that the agent understands the ethical duties undertaken through the appointment by the insurance carrier. The agent views and acknowledges the code of conduct by checking a box in the web page to electronically sign the code of conduct. Thus, the code of conduct is received via the network from the agent (Step 424) and saved. It is noted that in embodiments where the insurance carrier contracts directly with the agent, a signed code of conduct may already be on file with the insurance carrier; thus, Steps 422 and 424 are not performed. However, these steps are performed if the carrier does not have such a code of conduct on file or requires an updated signed code of conduct.

Next, the system transmits a background check authorization to the agent for display via the network (Step 426). In one embodiment, the background check authorization is an authorization formatted in a web page that the agent can electronically sign by checking a box and indicates that the agent authorizes the insurance carrier to investigate the background records of the agent. The agent views then signs the page and submits it back to the system. Thus, the system receives the electronically signed background check authorization from the agent via the network (Step 428) and saves. Next, a confirmation of the submitted application is sent for display to the general agent via the network (Step 430). It is noted that in embodiments where the insurance carrier contracts directly with the agent, a signed background check authorization may already be on file with the insurance carrier; thus, Steps 426 and 428 are not performed. However, these steps are performed if the carrier does not have such a background check authorization on file or requires an updated background check authorization.

At this point, in this embodiment, the system determines whether one or more of the states being applied for are sensitive states (Step 432). If one or more states are sensitive states (Step 432), i.e., expedited processing is required, then the system automatically generates an e-mail or other electronic notification which is transmitted to the licensing department via the computer network instructing that the application be processed (Step 434). In one embodiment, the licensing staff in the licensing department of the insurance carrier receives the e-mail to process the appointment application and then triggers the automatic pinging of an external database, e.g., the NIPR web site. For example, in one embodiment, the notification or e-mail includes a link that when clicked will trigger the automatic pinging process. Upon this triggering, the system automatically transmits via the computer network a request for licensing information to an external database (Step 438). It is also noted that in some embodiments, securities registration information may also be requested by automatically transmitting via the computer network a request to another external database (e.g., the NASD web site) for the securities registration information. This may be done, for example, through the execution of a bot to login to one or more external databases and request the appropriate information. Next, the system receives the licensing information (and optionally, the securities registration information) via the computer network (Step 440) and saves the information (Step 442).

It is also noted that the system may also automatically transmit a request for an agent's credit report via the computer network to a third party vendor or to an appropriate credit reporting agency. Thus, the agent's credit report is received via computer network. This request for a credit report may occur at any time after receipt of the electronically signed background check authorization (e.g., after Step 428).

In the event there are no sensitive states being applied for (Step 432), the system stores the application and waits until it receives a notification that new business has been received from the agent (Step 436) and then performs Steps 438, 440 and 442. This notification may be a trigger generated by the licensing department of the insurance carrier (once the licensing department of the carrier is notified of the new business) or may be generated by another division or system of the insurance carrier.

It is noted that in some embodiments, depending on the regulations for the given generic states, there is no sensitive state/non-sensitive state distinction, such that automatically, either Step 434 or Step 436 is performed without performing Step 432.

It is noted that in other embodiments, Step 438 is triggered earlier in the process, for example, any time in the process once sufficient identifying agent data has been collected (possible as early as Step 406). In one example, Steps 438, 440 and 442 occur after Step 428 and before Step 434 or Step 436. As such, the triggering of the automatic pinging is done by the appointment application system itself. Next, the licensing staff continue to process the application for final submission to the state. It is noted that in some embodiments, the insurance carrier already has the agent's license information since the agent contracts with the insurance carrier such that Steps 438, 440 and 442 are not performed. However, in some embodiments, Steps 438, 440 and 442 are performed even though the carrier already has the agent's license information in order to update the agent's license information as stored.

It is further noted that the process of FIG. 4 is generally the same whether the insurance carrier contracts with the agent only, the general agent only, or both the agent and the general agent; however, the information required from the agent and the general agent to process the appointment application may differ. The order of the steps of FIG. 4 represent only one embodiment and it is noted that the order of these steps may be altered depending on the specific implementation and be in accordance with the invention.

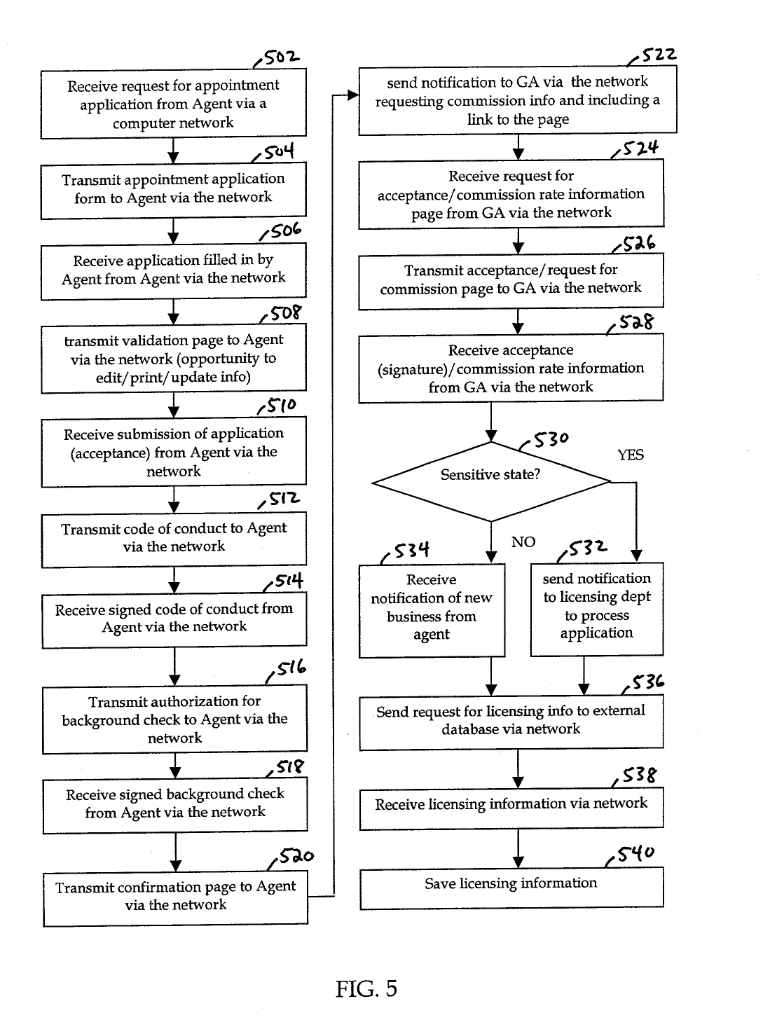

Referring next to FIG. 5, a flowchart is shown illustrating the steps performed using another embodiment of the appointment application system in which the appointment application is initiated by an agent. Thus, the flowchart of FIG. 5 illustrates in more detail another embodiment of the steps of FIG. 3 as performed by the appointment application system relative to the parties involved including the agent and the general agent.

Initially, a request for an appointment form is received from the agent via the computer network (Step 502). For example, the agent has logged on the appointment application website and has requested the appropriate starting page. Next, the appointment application is transmitted for display to the agent via the computer network (Step 504), e.g., as one or more web pages (.JSP pages). At this point the agent enters the information about the agent, the state(s) and product(s) applied for (i.e., wishes to solicit the sale of), employment history, a network address for the agent (e.g., an e-mail address), the general agent, a computer network address for the general agent (e.g., e-mail address), etc., and then submits the page(s). Depending on whether the insurance carrier contracts with the agent or the general agent, more or less information about the agent or general agent may be required. For example, if the carrier contracts with the general agent, the system may already know or have access to the general agent's network address; thus, the system does not prompt the agent for this information. Likewise, if the carrier contracts with the agent, the system may already know the agent's network address. Thus, the application as filled in by the agent is received at the system 104 via the computer network (Step 506). The system stores the application and data in a database, e.g., in the database server 208 using the database server adapter 216. The system then transmits a validation page for display to the agent via the computer network (Step 508), which allows the agent to verify the accuracy of the information entered and edit, if necessary. Once the agent has confirmed the information entered, the agent submits the application by accepting the validation page. Thus, the system receives an acceptance of the appointment application from the agent via the computer network (Step 510). At this point, the application is saved in the system database.

Next, the system transmits a code of conduct for display to the agent via the computer network (Step 512), e.g., within a web page. The agent views and acknowledges the code of conduct by checking a box in the web page to electronically sign the code of conduct. Thus, the code of conduct is received via the network from the agent (Step 514) and saved. It is noted that in embodiments where the insurance carrier contracts directly with the agent, a signed code of conduct may already be on file with the insurance carrier; thus, Steps 512 and 514 are not performed. However, these steps are performed if the carrier does not have such a code of conduct on file or an updated signed code of conduct is required.

Next, the system transmits a background check authorization for display to the agent via the network (Step 516). In one embodiment, the background check authorization is an authorization formatted in a web page that the agent can electronically sign by checking a box and indicates that the agent authorizes the insurance carrier to investigate the background records of the agent. The agent views then electronically signs the check and submits it back to the system. Thus, the system receives the signed background check authorization from the agent via the network (Step 518) and saves. It is noted that in some embodiments, the background check authorization is already on file with the insurance carrier since the carrier already has a contractual relationship with the agent; thus, in these embodiments, Steps 516 and 518 may not be performed. However, it is noted that Steps 516 and 518 are performed if the carrier does not have such a background check authorization on file or requires an updated background check authorization.

Next, a confirmation of the submitted application is transmitted for display to the agent via the computer network (Step 520). This confirmation indicates that the application is complete from the agent's standpoint and further requires additional information from the general agent.

Next, a notification (such as an e-mail) requesting commission rate information (or other required information) and review is automatically transmitted to the general agent (GA) via the computer network (Step 522). According to one embodiment, the e-mail includes a link to a page (or multiple pages) generated by and transmitted by the appointment application system 104 that will prompt for additional information (e.g., the commission rate information or the commission level), still required, and optionally, display the application for review. It is noted that the additional information required may depend on the relationship between the insurance carrier and the parties involved. For example, more information may be required from the general agent if the carrier does not contract with the general agent. Likewise, less information may be required if the carrier contracts with the general agent; however, generally, the carrier does not know the commission level even if it contracts with the general agent. Thus, a request is received via the computer network from the general agent for such a commission rate information/acceptance page (Step 524), which page is then transmitted for display via the computer network to the general agent (Step 526). In some embodiments, this page provides the general agent with the opportunity to review and edit the information. Once the general agent has entered the commission rate information and confirmed the information in the application, the general agent submits the completed page, and thus, the system receives via the network the commission rate information and confirmation from the general agent (Step 528).

At this point, in this embodiment, the system determines whether one or more of the states being applied for are sensitive states (Step 530). If one or more states are sensitive states (Step 530), i.e., expedited processing is required, then the system automatically generates an e-mail or other electronic notification which is transmitted to the licensing department via the computer network instructing that the application be processed (Step 532). In one embodiment, the licensing staff in the licensing department of the insurance carrier receives the e-mail to process the appointment application and then triggers the automatic pinging of an external database, e.g., the NIPR web site. Again, in some embodiments, the notification or e-mail contains a link which when clicked, executes the automatic pinging process. Upon this triggering, the system automatically transmits via the computer network a request for licensing information to an external database (Step 536). It is also noted that in some embodiments, securities registration information may also be requested by automatically transmitting via the computer network a request to another external database (e.g., the NASD web site) for the securities registration information. This may be done, for example, through the execution of a bot to login to one or more external databases and request the appropriate information. Next, the system receives the licensing information (and optionally, the securities registration information) via the computer network (Step 538) and saves the information (Step 540).

It is also noted that the system may also automatically transmit a request for an agent's credit report via the computer network to a third party vendor or to an appropriate credit reporting agency. Thus, the agents credit report is received via computer network. This request for a credit report may occur at any time after receipt of the electronically signed background check authorization (e.g., after Step 518).

In the event there are no sensitive states being applied for (Step 530), the system stores the application and waits until it receives a notification that new business has been received from the agent (Step 534) and then performs Steps 536, 538 and 540. This notification may be a trigger generated by the licensing department of the insurance carrier (once the licensing department of the carrier is notified of the new business) or may be generated by another division or system of the insurance carrier.

It is noted that in other embodiments, Step 536 is triggered earlier in the process, for example, any time in the process once sufficient identifying agent data has been collected (for example, as early as after Step 506). In one example, Steps 536, 538 and 540 occur after Step 518 and before Step 532 or Step 534. Next, the licensing staff continue to process the application for final submission to the state. It is noted that in some embodiments, the insurance carrier already has the agent's license information since the agent contracts with the insurance carrier such that Steps 536, 538 and 540 are not performed. However, in some embodiments, Steps 536, 538 and 540 are performed even though the carrier already has the agent's license information in order to update the agent's license information as stored.

It is further noted that the process of FIG. 5 is generally the same whether the insurance carrier contracts with the agent only, the general agent only, or both the agent and the general agent; however, the information required from the agent and the general agent to process the appointment application may differ. The order of the steps of FIG. 4 represent only one embodiment and it is noted that the order of these steps may be altered depending on the specific implementation and be in accordance with the invention.

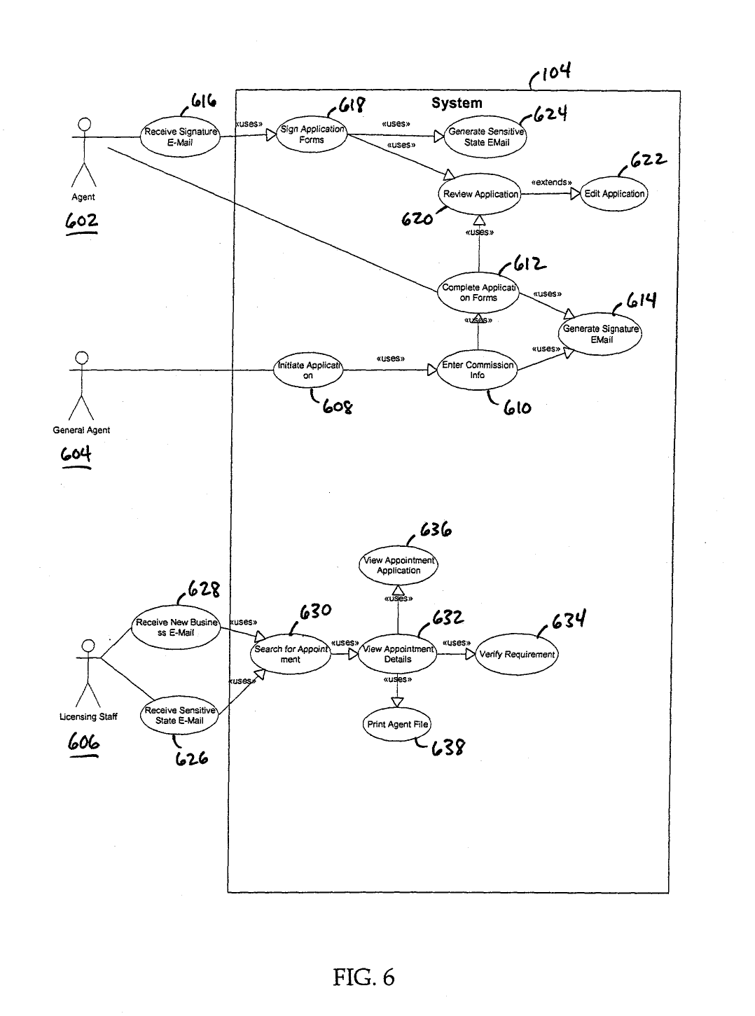

Referring next to FIG. 6, a diagram illustrating the interactions between an agent 602, a general agent 604 and the licensing staff 606 with an appointment application system 104 according to another embodiment of the invention in which the general agent 604 initiates the appointment application and the insurance carrier contracts with the general agent. The licensing staff 606 represents employees of the insurance carrier who are responsible for the processing of the appointment application. The following discussion illustrates several use cases to be executed through the system 104 (e.g., caused to be executed by the appointment manager 212). Also illustrated are the parties involved and the interactions with the appointment application system 104. For example, as described above, the system according to one embodiment, is implemented as a web server system that is coupled to a computer network 102 and generates web pages (e.g., Java Server pages) that are transmitted for display on the various user's computers and received back from various users in an appointment application process in the insurance industry.

In this embodiment, the Initiate Application Use Case 608 is accessible to the general agent (GA) 604, who accesses the system 104 through the general agent's intranet (e.g., intranet 108). The general agent enters initial identifying information about the agent to be appointed, including the agent's name and the agent's producer id.

Next, the Enter Commission Information Use Case 610 is executed by the system 104. This Use Case is accessible to the general agent 604. It is executed by the Initiate Application Use Case 608. The general agent enters commission rate information (or commission level) for the new agent appointment. When complete, the general agent 604 can choose to enter additional information about the appointment request through the Complete Application Forms Use Case 612, or save the appointment request and generate a signature e-mail 614 or other electronic notification to the agent 602.

The Complete Application Forms Use Case 612 may be executed by either a general agent (GA) 604 or the writing agent 602. In one embodiment, the visitor accesses the appointment application system 104 from a general agent's intranet site (e.g., intranet 108), meeting the general agent's authentication requirements. The agent 602 may enter system through the Internet 106 or the intranet 108. The link to the system includes a parameter that identifies which general agent the application is being invoked for. The system 104 responds with the first application form, which is transmitted for display to the user via the computer network.

As described above, the first application form transmitted to the user, either the agent or the general agent, prompts the user for information about the appointment: which underwriting company is being applied for, the type of legal entity (individual, corporate, etc.), the states being applied for (i.e., wishes to solicit the sale of), the product(s) or product line the agent wishes to solicit the sale of, and the type of licenses currently held. The user enters the information and submits the form. Next, the application form prompts the user for personal information about the producer or agent: name, business and residential address, social security number, e-mail address (e.g., computer network address), CRD registration number, registration series, broker-dealer, etc. The user enters the information and submits the form. The system 104 then prompts the user for background information about the agent or producer (questions are taken verbatim from the paper appointment application form). The user submits the form. For example, in one embodiment, for agents in Florida, Mississippi, Alabama, Georgia, Ohio, and Pennsylvania, the system prompts the user for the producer's employment history for the last five years. The user enters the information and submits the form. It is also noted that this information may be requested in response to the transmission of multiple web pages, some web pages may be automatically transmitted only to the agent or the general agent.

The system 104 then displays a validation page (see Edit Application Use Case 622, described below) with the information previously entered and allows the user (e.g., either the agent or the general agent) to update any information. The user verifies that all information is correct and accepts the application. As a result, the information is saved in a database, e.g., a database server, and an e-mail message or other electronic notification is sent to the writing agent 602, informing them that the application is ready to be signed.

The Generate Signature E-mail Use Case 614 is executed from the Complete Application Forms Use Case 612 and Enter Commission Info Use Case 610. When the visitor has either completed personal information on an application (e.g., the complete application forms Use Case 612), or initiated an application by completing commission forms (e.g., the Enter Commission Information Use Case 610), an e-mail message is generated and sent to the agent 602 via the computer network.

The Receive Signature E-mail Use Case 616 is executed by the agent 602. The agent 602 receives an incoming e-mail in response to the Generate Signature E-mail Use Case 614. The e-mail message contains instructions for the agent 602 along with a link to page implementing the Sign Application Forms Use Case 618. The link includes identification of the general agent 604 and a unique ID that identifies the application.

According to this embodiment, the Sign Application Forms Use Case 618 is executed by the writing agent 602, and may be triggered by an e-mail message to the writing agent (e.g., Receive Signature E-mail Use Case 616). The system 104 displays the validation page with the information previously entered and allows the writing agent 602 to update any information in the Review Application Use Case 620 and the Edit Application Use Case 622.

The Review Application Use Case 620 is executed from other Use Cases, including Complete Application Form Use Case 612 and Sign Application Forms Use Case 618. When the visitor, either the agent 602 or the general agent 604 finishes completing forms, the system 104 displays a review page that allows the visitor to verify that the correct information was entered. If the Review Application Use Case 612 is executed by the agent 602, commission rate information entered in the Enter Commission Information Use Case 610 will be hidden. The visitor can edit information on the page by selecting the edit button on each section where information is entered and making the appropriate edits. The visitor also has the option to save the application, along with an “Agent signature” requirement.

The Edit Application Use Case 622 extends Review Application Use Case 620. When the user wishes to change information that is displayed on the Review Application page generated, an “Edit” button or icon is selected for the section containing the information to be changed. The information is displayed in the page that was originally used to collect the information. When the user presses the “Continue” button or icon on the edit page, the visitor is returned to the Review Application page generated in the Review Application Use Case 620.

Upon completion of the Review Application Use Case 620 and the Edit Application Use Case 622, if needed, the agent 602 has confirmed that all information is correct. Thus, in the Sign Application Use Case 618, upon confirmation, a new form presents the writing agent 602 a code of conduct agreement and date, and prompts the user to sign electronically by clicking a box. The Agent clicks on the box and submits the form.

Upon submission, a background check authorization form is transmitted for display to the writing agent 602 and is a consent to request consumer report and/or investigative consumer information, along with the Agent's name, social security number, tax identification number, agent identification code, Date of Birth, Driving license number, and address, and date. The form prompts the user to indicate if the appointment application is for General Agent, Agent or Broker, and then to sign electronically by clicking a box. The Agent clicks on the box and submits the form.

As a result, the system 104 generates a confirmation page, the information is saved in the database server, including timestamps for electronically signed forms.

Next, the Generate Sensitive State E-mail Use Case 624 is executed by the system 104 from the Sign Application Forms Use Case 618, and only for sensitive states. When the agent has signed the application and consent forms, an e-mail message is generated and sent to the licensing staff 606 informing them that appointment application has been received for a sensitive state.

Next, from the viewpoint of the licensing staff 606, the Receive Sensitive State E-mail Use Case 626. After logging in to the system 104, the user, i.e., licensing staff member of the insurance carrier, is presented with an incoming e-mail including information about a new appointment for a writing agent including a sensitive state, which should be processed as soon as possible.

Alternatively, the Receive New Business E-mail Use Case 628 is executed by the licensing staff 606. After logging in to the system, the user is presented with an incoming e-mail including information about new business from a writing agent who has not been appointed yet in the corresponding state. In one embodiment, this incoming email is generated by insurance carrier personnel who are not part of the licensing staff, but who learn of the new business.

In response to either the Receive Sensitive State E-mail Use Case 626 or the Receive New Business E-mail Use Case 628, the licensing staff executes the Search for Appointment Use Case 630. Thus, the user requests a search form, which is transmitted for display to the user. The user enters the general agent and Agent information and submits the request form and in response, the system generates and transmits a page containing all the agent's appointment information. In the Search for Appointment Use Case 630, after logging in to the system 104, the user is presented with a form prompting for the general agent (GA) code, and either the writing agent's social security number/Tax identification number or his/her First and Last Name. An asterisk may be placed in some of the fields to indicate that any value would be accepted. As a result, the user would see a page displaying a table indicating, for each appointment (pending or not) the GA code, Writing Agent's Full Name and Tax ID number, US State of Appointment, underwriting company and current Status of the appointment. In many instances, there may be cases in which the result of the search is not unique, in the sense that it renders several writing agents. The user will then have the option to click on a “next” button to look for the next agent.

Authorized users (licensing staff) also have the option to click on a button and see detailed Agent Appointment Information in the View Appointment Details Use Case 632, which is executed by the licensing staff 606 in this embodiment. In the View Appointment Details Use Case 632, the user is presented with a page including three sections. In other words, the system 104 generates a web page and transmits it to the licensing staff for display via the computer network. In a first section, information about the writing agent, as well as the GA code, are displayed. A second section displays, for each appointment, the US State, Underwriting Company and current Status of Appointment. And a third section displays the requirements that have to be met for the Agent to be appointed in any of the states. For example, requirements may include availability of governmental or State license information (available via an external database, e.g., the NIPR web site, or in paper form), NASD and U4 form (available via an external database, e.g., the NASD web site, or in paper form), State approval, in sensitive states, and other. The view will show which requirements have been met.

Next, the Verify Requirement Use Case 634 is executed by the licensing staff 606 from the View Appointment Details Use Case 632. For example, appointment requirements are listed on the appointment details screen. The user selects the “update” button or icon for a requirement line, to indicate that it is now met. The update in the Requirements may result in a change in the status of the appointment. It is noted that the results of automatic pinging of an external database may also be indicated here. For example, depending on the embodiment, if the license information has already been obtained and stored, the Verify Requirements Use Case 634 will so indicate to the user.

Furthermore, a Verify License Requirement Use Case (not shown) may be executed by the licensing staff 606 as an extension of Verify Requirement Use Case 634. The user would view in the detailed form the requirements necessary for the state(s) requested for appointment. The requirement line will indicate if the corresponding state has information in an external database, e.g., NIPR web site. The user can initiate the pinging of the external database, if it has not already been done by the system 104. For example, the user enables a bot to login to the external database, e.g., the NIPR web site, and navigate through it until it gets the page where the Licensing information for the writing agent is available. Thus, in this embodiment, the pinging of the external database is automated after being initiated by the user. In other embodiments, once the Sign Applicant Forms Use Case 618 is complete, a bot is enabled to ping the external database. After verification, the user may update the status for the requirement that is now met.

Furthermore, the Verify NASD Requirement Use Case (not shown) is an extension of the Verify Requirements Use Case 634 in the event the agent wishes to sell variable products. The user can view in the detailed form the requirements necessary for the state(s) requested for appointment. A requirement line indicates the need to verify securities registration information available from an external database, e.g., NASD. The user may click the “view” button or icon in the requirement line that enables a bot to login the NASD web site and navigate through it until it gets the NASD entry page for the writing agent. After verification, the user will update the status for the requirement that is now met (Verify NASD). Again, this process is automatic once triggered by the licensing staff 606; however, in some embodiments, it may be automatically executed without triggering by the licensing staff upon completion of the Sign Application Forms Use Case 618.

The Update Policy Administration/Licensing System Use Case (not shown) is executed by the licensing staff and as an extension of the Verify Requirements Use Case 634. When requirements for an appointment application are satisfied, the system 104 verifies that all necessary requirements are satisfied, retrieves details about general agent defaults from database server, and then triggers the appropriate transactions that are executed on the policy administration/licensing system or legacy system.

Next, the View Application Use Case 636 is executed. When the user selects an application for update or viewing, the application is transmitted for display to the licensing staff 606 by the system 104. For example, the system 104 generates web pages and transmits them to the user via the computer network 102 (through the Internet 106 and the intranet 108, if applicable). In this Use Case, the user can only view, not edit information.

The Print Agent File Use Case 638 can be executed only by licensing staff and allows the licensing staff to print the agent file. This triggers a process to format the different pieces of information available electronically (agent information, agreements, NIPR, NASD information) that are stored in the database and send it to print. In many cases, a carrier must keep paper records of appointment information for audit purposes.

It is noted that one may change to functionality of the various Use Cases of FIG. 6 to implement an appointment application process where the insurance carrier contracts only with the agent, or with the agent and the general agent.

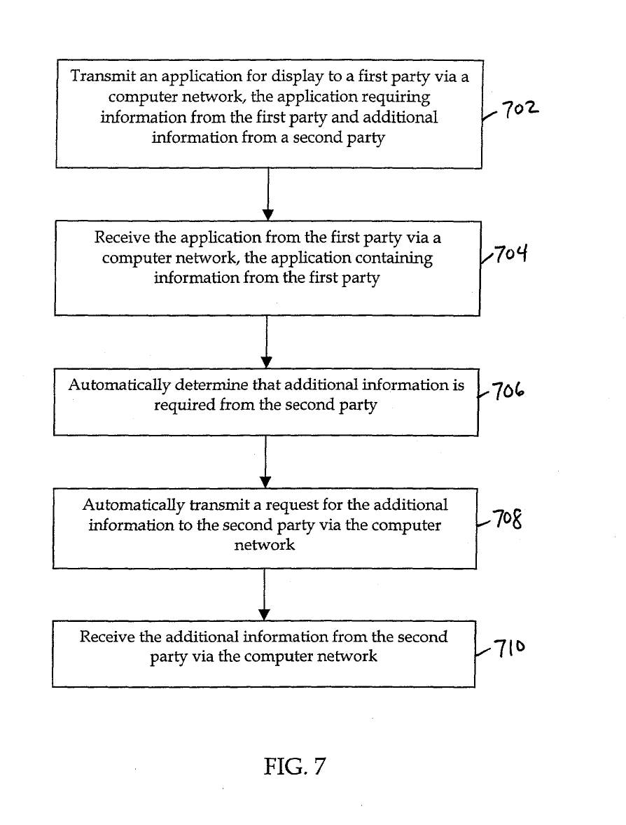

Referring next to FIG. 7, a flowchart illustrating the steps performed in another embodiment of the invention using a computer network in which information is required from multiple parties in order to complete an application process.

Initially, a system (e.g., a website) implementing an application process using a computer network transmits an application for display to a first party via a computer network, the application requiring information from the first party and additional information from a second party (Step 702). For example, in one embodiment, the application is an online appointment application for use in the insurance industry, the first party is one of an agent and a general agent (GA), the second party is the other of the agent or the general agent, and the additional information may be either commission rate information if the first party is the agent or may be a background check authorization if the first party is the general agent. The first party then completes the application with the information available to the first party and transmits the application back to the system.

Next, the system receives the application from the first party via a computer network including the information from the first party (Step 704) and automatically determines that additional information is required from the second party (Step 706). Then, the system automatically transmits a request for the additional information to the second party via the computer network (Step 708). In one embodiment, an e-mail or other electronic notification is transmitted to the second party via the computer network, the e-mail requesting the additional information to be provided. For example, this e-mail may include a link to a web page that will provide the input fields for the second party to submit the additional information. This web page is transmitted for display to the second party via the network. By way of example, in one embodiment, for example, an appointment application system determines that a background check authorization is needed from the agent (i.e., second party in this case) and transmits an e-mail to the agent including a link to a web page that will allow the agent to electronically sign the background check authorization.

The second party then transmits the additional information back to the system via the network. Thus, the system receives the additional information from the second party via the computer network (Step 710). Thus, such a system advantageously allows an application to be applied for that requires information from multiple parties, but is initiated by one of the parties and may be completed for processing purposes without coordination between the multiple parties to provide the information. It is noted that although this embodiment has been described in terms of an appointment application in the insurance business, the steps of FIG. 7 may be performed in other systems having other types of online application processes that utilize a computer network.

While the invention herein disclosed has been described by means of specific embodiments and applications thereof, numerous modifications and variations could be made thereto by those skilled in the art without departing from the scope of the invention set forth in the claims.

What is claimed is:

1. An automated method using a computer network comprising:
receiving an appointment application for the appointment of an agent by an insurance carrier via the computer network, the appointment application including agent data, a state the agent is seeking an appointment, and a product the agent wishes to solicit;
transmitting a request for additional information about the agent to an external database via the computer network; and
receiving the additional information from the external database via the computer network.

2. The method of claim 1 wherein the transmitting the request step comprises:
requesting an information request web page from the external database via the computer network;
receiving the information request web page;
inserting agent information about the agent into the information request web page; and
transmitting the information request web page to the external database via the computer network.

3. The method of claim 2 wherein the receiving the additional information step comprises:
receiving a web page containing the additional information from the external database via the computer network.

4. The method of claim 1 wherein the additional information comprises licensing information about the agent for the state the agent is seeking the appointment.

5. The method of claim 1 wherein the additional information comprises securities registration information about the agent.

6. The method of claim 1 further comprising:
receiving an electronically signed background check authorization from the agent via the computer network, wherein the transmitting the request step comprises:
transmitting the request in response to the receiving the electronically signed background check authorization step.

7. The method of claim 1 wherein the transmitting the request step comprises:
transmitting the request in response to the receiving the appointment application step.

8. The method of claim 1 further comprising:
receiving a notification from a licensing staff member of the insurance carrier indicating that the appointment application is ready for processing, wherein the transmitting the request step comprises:
transmitting the request in response to the receiving the notification step.

9. The method of claim 1 wherein the transmitting the request step comprises:
transmitting the request for the additional information about the agent via the computer network from a website of the National Insurance Producer Registry (NIPR) or a website of the National Association of Security Dealers (NASD).

10. The method of claim 1 further comprising:
transmitting, prior to the receiving the appointment application step, the appointment application for display and appointment information entry via the computer network.

11. The method of claim 1 further comprising:
storing information provided in received appointment application in a database; and
storing the received license information in the database.

12. The method of claim 1 wherein the receiving the appointment application step comprises:
receiving a web page containing at least a portion of the appointment application.

13. The method of claim 1 wherein the receiving the appointment application step comprises:
receiving the appointment application from a general agent contracting with the agent via the computer network.

14. The method of claim 1 wherein the receiving the appointment application step comprises:
receiving the appointment application from the agent via the computer network.

15. The method of claim 1 further comprising:
transmitting a notification to a licensing staff member of the insurance carrier via the computer network to process the appointment application.

16. The method of claim 1 further comprising:
transmitting, in response to the receiving the appointment application step, a request for a background check authorization to the agent via the computer network; and
receiving an electronically signed background check authorization from the agent via the computer network.

17. The method of claim 1 further comprising:
transmitting, in response to the receiving the appointment application step, the appointment application for display and review to the agent via the computer network.

18. The method of claim 17 further comprising:
receiving a confirmation from the agent via the computer network that the information in the appointment application is accurate.

19. The method of claim 17 further comprising:
receiving an edited appointment application from the agent via the computer network, the edited appointment application including additional information about the agent to complete the appointment application.

20. The method of claim 1 further comprising:
transmitting, in response to the receiving the appointment application step, a request for a commission level of a general agent contracting with the agent via the computer network, the commission level provided in the relationship between the agent and the general agent; and
receiving the commission level from the general agent via the computer network.

21. An automated method using a computer network:
receiving an appointment application for the appointment of an agent by an insurance carrier via a computer network, the appointment application including agent data, a state the agent is seeking an appointment for, and a product the agent wishes to solicit;
transmitting, in response to the receiving the appointment application, a request for a background check authorization for display to the agent via the computer network; and
receiving an electronically signed background check authorization from the agent via the computer network.

22. The method of claim 21 wherein the receiving the appointment application comprises receiving the appointment application from a general agent contracting with the agent via the computer network.

23. The method of claim 22 wherein the received appointment application includes a commission level of the general agent as provided in the relationship between the agent and the general agent

24. The method of claim 21 wherein the transmitting the request step comprises:
transmitting, in response to the receiving the appointment application, an electronic notification to the agent via the computer network, the electronic notification requesting authorization to perform a background check and including a link to a background check authorization web page.

25. The method of claim 24 further comprising:
receiving, in response to the transmitting the request step, a request for the background check authorization web page from the agent via the computer network; and
transmitting the background check authorization web page for display to the agent via the computer network;
wherein the receiving the electronically signed background check authorization step comprises:
receiving the background check authorization web page having been electronically signed from the agent via the computer network.

26. The method of claim 21 further comprising:
transmitting, in response to the receiving the appointment application step, the appointment application for display to the agent via the computer network.

27. The method of claim 26 further comprising:
receiving a confirmation from the agent via the computer network that the information in the appointment application is accurate.

28. The method of claim 27 wherein the transmitting the request step comprises:
transmitting the request, in response to the receiving the confirmation from the agent step.

29. The method of claim 26 further comprising:
receiving an edited appointment application from the agent via the computer network, the edited appointment application including additional information about the agent to complete the appointment application.

30. The method of claim 29 wherein the transmitting the request step comprises:
transmitting the request, in response to the receiving the edited application from the agent step.

31. The method of claim 26 wherein the appointment application is received from a general agent contracting with the agent, and wherein the transmitting the appointment application step comprises:
transmitting, in response to the receiving the appointment application step, an electronic notification to the agent via the computer network, the electronic notification indicating that the appointment application submitted on behalf of the agent is ready for review, the electronic notification including a link to an application validation web page.

32. The method of claim 31 further comprising:
receiving a request for the application validation web page from the agent via the computer network;
transmitting the application validation web page for display to the agent via the computer network; and
receiving the application validation web page from the agent via the computer network, the application validation web page indicating that information in the appointment application is accurate.

33. The method of claim 26 wherein the transmitting the appointment application step comprises:
transmitting, in response to the receiving the appointment application step, an electronic notification to the agent via the computer network, the electronic notification indicating that the appointment application submitted on behalf of the agent requires additional information, the electronic notification including a link to an application information entry web page.

34. The method of claim 33 further comprising:
receiving a request for the application information entry web page from the agent via the computer network; and
transmitting the application information entry web page for display to the agent via the computer network; and
receiving the application information entry page including the additional information from the agent via the computer network.

35. The method of claim 21 further comprising:
transmitting a request for additional information about the agent from an external database via the computer network; and
receiving the additional information from the external registry via the computer network.

36. The method of claim 21 further comprising:
transmitting, prior to the receiving the appointment application step, the appointment application for display and appointment information entry via the computer network.

37. The method of claim 21 further comprising:
storing information provided in received appointment application in a database; and
storing the signed background check authorization in the database.

38. The method of claim 21 wherein the receiving the appointment application step comprises:
receiving a web page via the computer network, the web page containing at least a portion of the appointment application.

39. An automated method using a computer network:
receiving an appointment application for the appointment of an agent by an insurance carrier via a computer network, the appointment application including agent data, a state the agent is seeking an appointment for, and a product the agent wishes to solicit;
transmitting, in response to the receiving the appointment application, a request for display to a general agent contracting with the agent via the computer network, the request for a commission level of the general agent, the commission level being provided in the relationship between the agent and the general agent; and
receiving the commission level from the general agent via the computer network.

40. The method of claim 39 wherein the receiving the appointment application comprises:
receiving the appointment application from the agent via the computer network.

41. The method of claim 39 wherein the transmitting the request step comprises:
transmitting, in response to the receiving the appointment application, an electronic notification to the general agent via the computer network, the electronic notification requesting the commission information and including a link to a commission entry web page.

42. The method of claim 41 wherein the electronic notification comprises an email.

43. The method of claim 42 further comprising:
receiving a request for the commission entry web page from the general agent via the computer network; and
transmitting the commission entry web page for display to the general agent via the computer network;
wherein the receiving the commission level step comprises:
receiving the commission entry web page including the commission level from the general agent via the computer network.

44. The method of claim 39 further comprising:
transmitting a request for additional information about the agent from an external database via the computer network; and
receiving the additional information from the external registry via the computer network.

45. The method of claim 39 further comprising:
transmitting, prior to the receiving the appointment application step, the appointment application for display and appointment information entry via the computer network.

46. The method of claim 39 further comprising:
storing information provided in received appointment application in a database; and
storing the commission information in the database.

47. The method of claim 39 wherein the receiving the appointment application step comprises:
receiving a web page via the computer network, the web page containing at least a portion of the appointment application.

48. A method for application processing via a computer network comprising:
receiving an application from a first party via a computer network, the application containing information from the first party and requiring additional information from a second party to complete the application;
determining that the additional information from the second party is needed;
automatically transmitting a request for the additional information to the second party via the computer network; and
receiving the additional information from the second party via the computer network.

49. The method of claim 48 wherein the transmitting comprises transmitting an electronic notification to the second party requesting the additional information, the electronic notification including a link to an information submission web page.

50. The method of claim 49 wherein electronic notification comprises an email.

51. The method of claim 49 further comprising:
receiving a request for the information submission web page from the second party via the computer network; and
transmitting the information submission web page for display to the second party via the computer network;
wherein the receiving the additional information step comprises:
receiving the information submission web page including the additional information from the second party via the computer network.

52. An automated appointment application system using a computer network comprising:
a server including a processor adapted to perform the following steps:
receiving an appointment application for the appointment of an agent by an insurance carrier via the computer network, the appointment application including agent data, a state the agent is seeking an appointment, and a product the agent wishes to solicit;
transmitting a request for additional information about the agent from an external database via the computer network; and
receiving the additional information from the external registry via the computer network.

53. An automated appointment application system using a computer network comprising:
a server including a processor adapted to perform the following steps:
receiving an appointment application for the appointment of an agent by an insurance carrier via a computer network, the appointment application including agent data, a state the agent is seeking an appointment for, and a product the agent wishes to solicit;
transmitting, in response to the receiving the appointment application, a request for a background check authorization for display to the agent via the computer network; and
receiving an electronically signed background check authorization from the agent via the computer network.

54. An automated appointment application system using a computer network comprising:
a server including a processor adapted to execute an application for performing the following steps:
receiving an appointment application for the appointment of an agent by an insurance carrier via a computer network, the appointment application including agent data, a state the agent is seeking an appointment for, and a product the agent wishes to solicit;
transmitting, in response to the receiving the appointment application, a request for display to a general agent contracting with the agent via the computer network, the request for a commission level of the general agent, the commission level being provided in the relationship between the agent and the general agent; and
receiving the commission level from the general agent via the computer network.

55. An automated appointment application system using a computer network comprising:
a first network interface server for transmitting and receiving web pages via the computer network, the web pages containing an appointment application for the appointment of an agent by an insurance carrier;
an application server for processing the information contained in the web pages and for determining if additional information is needed to complete the appointment application;
a second network interface server for transmitting electronic notifications via the computer network to the agent and a general agent contracting with the agent, at least one electronic notification indicating that the additional information is required to process the appointment application, the at least one electronic notification including a link to a web page that provides an entry field for the additional information;
wherein the application server requests through the first network interface server licensing information about the agent from an external database via the computer network; and
a database server for storing the appointment information, the additional information and the licensing information.
